(19) United States
(12) Patent Application Publication
(10) Pub. No.: US 2013/0344852 A1
(43) Pub. Date: Dec. 26, 2013

(54) DELIVERING TARGETED MOBILE MESSAGES TO WIRELESS DATA NETWORK DEVICES BASED ON THEIR PROXIMITY TO KNOWN WIRELESS DATA COMMUNICATION NETWORKS

(71) Applicant: Cezary Kolodziej, Deer Park, IL (US)

(72) Inventor: Cezary Kolodziej, Deer Park, IL (US)

(21) Appl. No.: 13/920,150

(22) Filed: Jun. 18, 2013

Related U.S. Application Data
(60) Provisional application No. 61/850,043, filed on Jun. 22, 2012.
(60) Provisional application No. 61/710,701, filed on Oct. 6, 2012.

(51) Int. Cl. H04W 4/20

(52) U.S. Cl. CPC H04W 4/20
USPC 455/414.1

(57) ABSTRACT

A network access controller of an apparatus in an example interacts with a proximity server to create an association between a mobile number and a media access control address of a wireless data network device.

### DESCRIPTION OF THE DRAWINGS

Features of exemplary implementations of the invention will become apparent from the description, the claims, and the accompanying drawings in which:

FIG. 1 is a representation of an implementation of an apparatus that comprises a wireless data network device, a wireless communication data network, a proximity server, and a mobile number provided by a user for mobile messaging communication.

FIG. 2 is a representation of an implementation of the apparatus of FIG. 1 and illustrates the wireless data network device interacting with the same instance of the wireless communication data network or a different instance of the wireless communication data network, where both wireless communication data networks are managed by the same proximity server.

FIG. 3 is a representation of a logic flow of an implementation of the apparatus of FIG. 1 and illustrates the proximity server controlling an access to one or more wireless data communication networks and interacting with a wireless signaling cellular network and/or wireless data cellular network to deliver targeted mobile messages after a full network access is granted.

FIG. 4 is a representation of the wireless data network device of an implementation of the apparatus of FIG. 1 and illustrates a media access control address of the wireless data network device.

### DETAILED DESCRIPTION

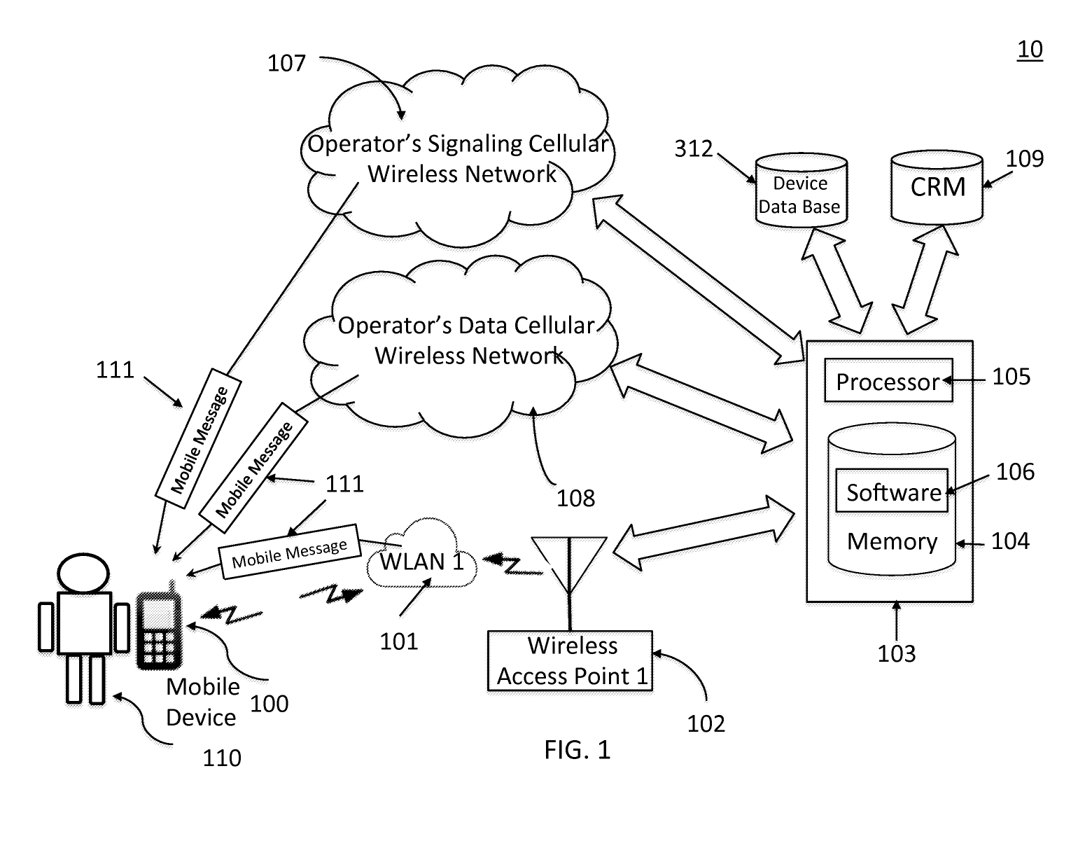

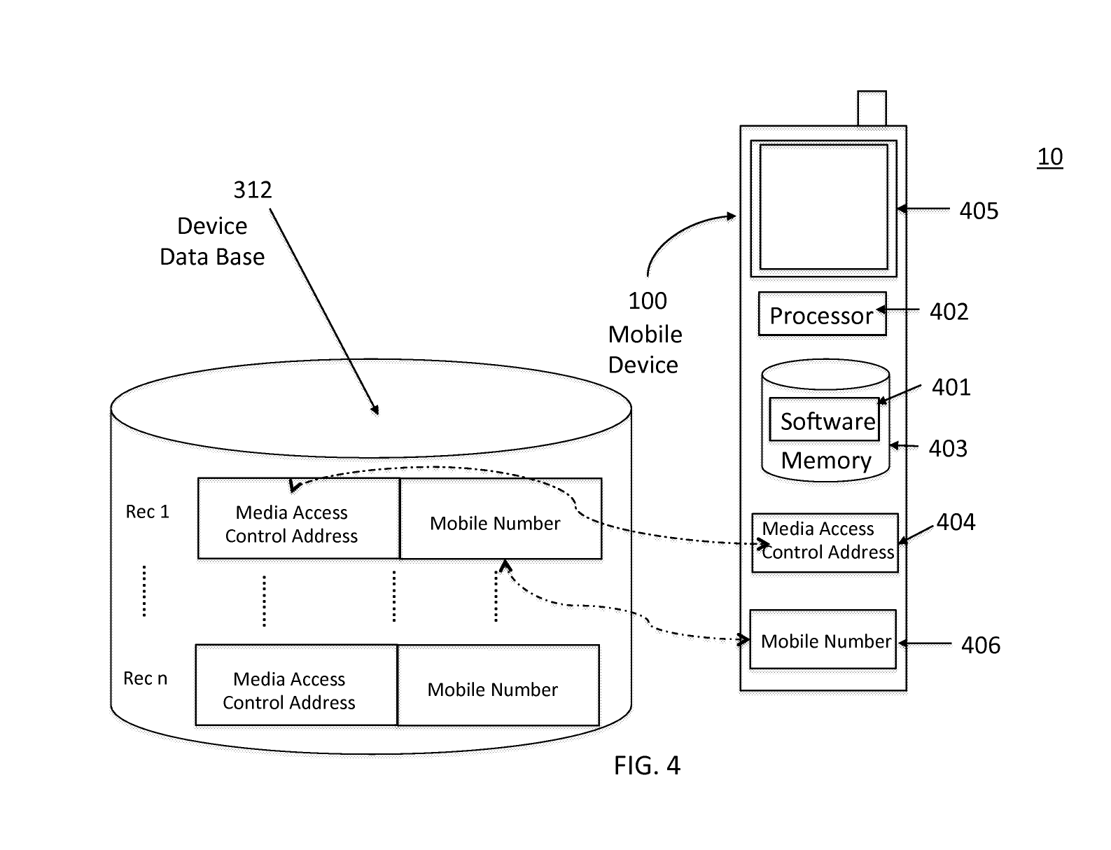

Turning to FIG. 1, an implementation of an apparatus 10 comprises a wireless data network device (100) that requests an access to a local wireless communication data network (101) by the wireless data network device (100) providing a media access control address (404) (FIG. 4) of the wireless data network device (100) to the local wireless communication data network (101). The wireless data network device (100) in an example comprises one or more of a mobile device, mobile phone, electronic tablet, wireless modem, personal digital assistant (pda), laptop, smartphone, and/or computing device. The wireless communication data network (101) in an example comprises a wireless local area network (WLAN).

Referring to FIG. 1 and FIG. 4, the wireless data network device (100) in an example interacts with the wireless communication data network (101) during an initial network access request controlled by a proximity server (103) and an association of the media access control address (404) of the wireless data network device (100) and a mobile number (406) of the wireless data network device (100) provided by a user (110) of the wireless data network device (100) for mobile messaging communication. Referring to FIG. 1, the user (110) in an example comprises one or more of a human, a woman, a man, an adult, a child, a customer, a player, a trainee, an intern, a student, a graduate, an elderly person, and/or a professional. Mobile messaging communication in an example comprises delivery and/or receipt of one or more mobile messages (111) Mobile messaging communication in an example comprises one or more of Short Message Service (SMS), Multimedia Messaging Service (MMS), Wireless Application Protocol-Push (WAP-Push) and/or in-application software (in-app) notification pushed/delivered to the wireless data network device (100) via one or more of a signaling cellular network (107), a data cellular network (108), and/or the local wireless communication data network (101). For example, the user (110) may be a customer of the signaling cellular network (107), the data cellular network (108), and/or the local wireless communication data network (101). The user (110) as the customer in an example employs the wireless data network device (100) for mobile communication and/or mobile messaging communication.

A network access controller (102) of the local wireless communication data network (101) in an example directs the network access request by the wireless data network device (100) with the media access control address (404) of the wireless data network device (100) to the proximity server (103). The proximity server (103) in an example searches the device database (312) for an entry with the provided media access control address (404).

Since such an entry in an example does not exist, the proximity server (103) in an example instructs the network access controller (102) to direct the network access request by the wireless data network device (100) to the registration webpage hosted by the proximity server (103) and renders the registration webpage on the wireless data network device's (100) screen (405) asking the user to provide a mobile number (406) so that the wireless data network device (100) can receive an access authorization confirmation for the local wireless communication data network (101) via a mobile message.

Referring to FIGS. 1 and 4, after the mobile number (406) is provided by the user (110) via the webpage and stored in the device database (312) by the proximity server (103), the proximity server (103) in an example delivers to the wireless data network device (100) the access authorization confirmation in the mobile message, for example, delivered via one or more of the signaling cellular network (107), the data cellular network (108), and/or the local wireless communication data network (101).

Referring to FIG. 1, the signaling cellular network (107) in an example comprises any signaling cellular network deployed by any mobile wireless operator for call set-up and short message services (SMS) such as GSM (Global System for Mobile Communications) and CDMA (Code Division Multiple Access). The data cellular network (108) in an example comprises any data cellular network deployed by any mobile wireless for providing internet data services on wireless data network devices such as 1x(1xRTT) (CDMA2000), 1xEV-DO (Evolution-Data Optimized), 3G (third generation of mobile telecommunications technology), and/or 4G (fourth generation of mobile telecommunications technology).

The access authorization confirmation message in an example requires the user (110) to reply with a confirmation reply mobile message content back to the proximity server (103). Since simple reply functionality of the wireless data network device (100) in an example is used, the confirmation reply mobile message in an example will be delivered back to the proximity server (103) via one or more of the signaling cellular network (107), the data cellular network (108), and/or the local wireless communication data network (101).

After the confirmation reply mobile message in an example is received by the proximity server (103), the authentication of the mobile number (406) in an example is complete and the proximity server (103) associates the mobile number (406) with the media access control address (404) of the initial request for the access to the local wireless communication data network (101) using its software (106) and executed by its processor (105). The proximity server (103) in an example stores the associated pair (the mobile number (406) and the media access control address (404)) in the device database (312).

After the association is successfully processed in an example the network access controller (102) grants the access of the wireless data network device (100) to the local wireless communication data network (101).

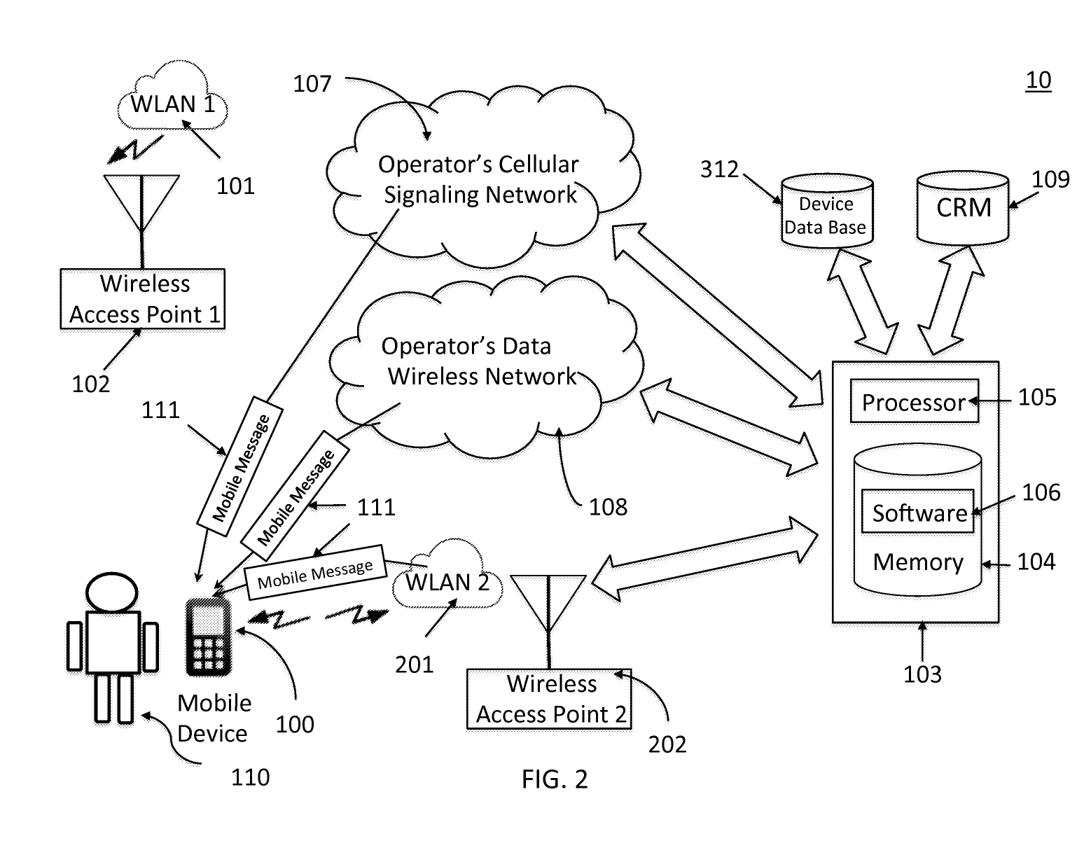

Turning to FIG. 2, an implementation of the apparatus 10 comprises a wireless data network device (100) requesting an access to a different instance of a local wireless communication data network (201) or the same instance as in FIG. 1 of the local wireless communication data network (101). Both instances of local wireless communication data networks (101, 201) in an example belong to a farm of two or more of wireless communication data networks controlled by the same proximity server (103).

A network access controller (102) or (202) of the local wireless communication data network (101) or (201), respectively, in an example directs the access request by the wireless data network device (100) to the proximity server (103). The proximity server in an example queries a device database (312) for an entry with the provided media access control address (404). Since such an entry in an example does exist, the proximity server (103) in an example instructs the network access controller (102) or (202), respectively, to allow the access to the local wireless communication data network (101) or (201), respectively, for the wireless data network device (100).

The software (106) stored in the memory (104) of the proximity server (103) in an example evaluates historical usage patterns of the wireless data network device (100) and its current proximity location within the physical coverage of the local wireless communication data network (101) or (201) via interaction with the customer relationship management (CRM) system (109)).

Based on results in an example the software (106) of the proximity server (103) pushes a mobile message (111) to the wireless data network device (100) with targeted advertisements (ads) or promotions via one or more of a cellular network (107), the data cellular network (108), and/or the local wireless communication data network (101) or (201).

A targeted ad in a mobile message (111) in an example can be related to a physical location of the local wireless communication data network (101). For example, the local wireless communication network (101) can be deployed near any type of store or small business. A targeted ad in a mobile message (111) in an example sent to the wireless data network device (100) in an example may promote a sale event at the store or small business and/or an additional discount on a purchase, for example, of $50 or more.

Where the user (110) is a customer and when the mobile number associated with the media access control address (404) reported by the wireless data network device (100) is associated with the customer's record in CRM (109) and the customer's record includes the history of previous purchases by the user (110) at the location where the local wireless communication data network (101) operates within, the targeted ad in a mobile message (111) in an example can be further incentivized to feature a product favored by the user (110), for example, take additional $10 off for another 30 minutes on the product favored by the user (110) and result in additional sales and profits by the small business.

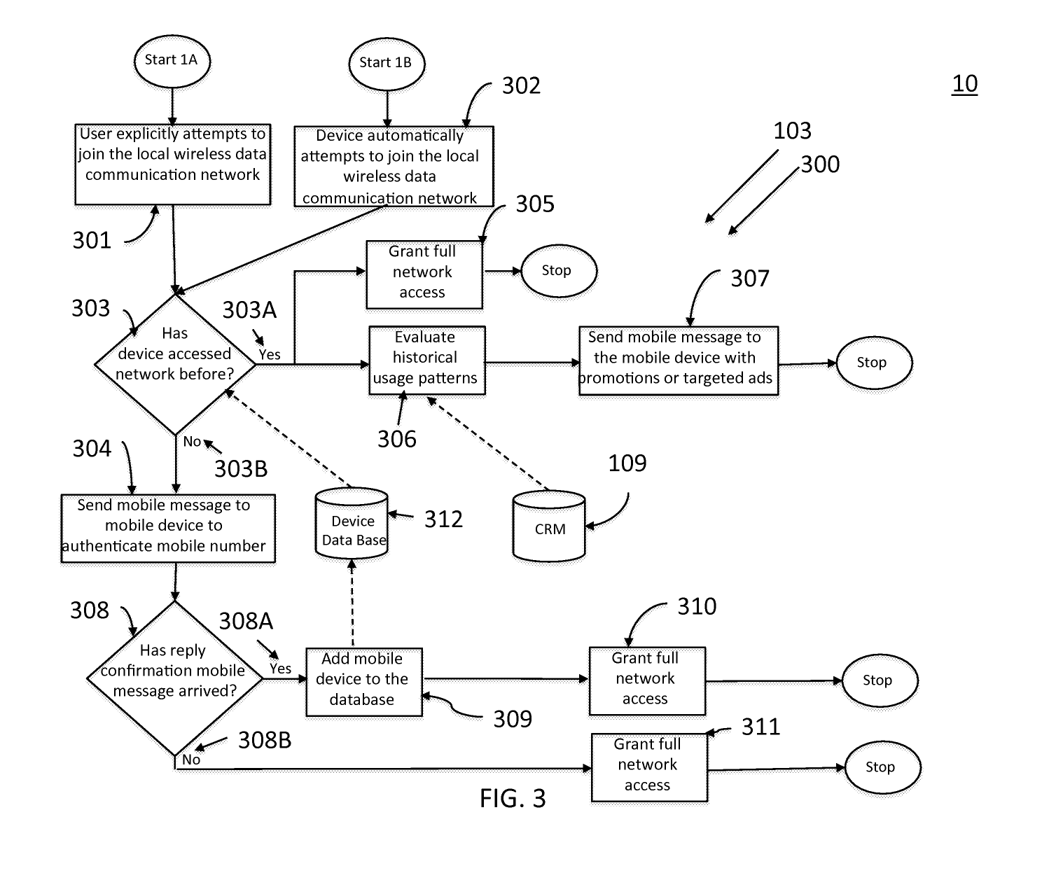

An illustrative description of an exemplary operation of an implementation of the apparatus 10 is presented, for explanatory purposes. Turning to FIG. 3, in exemplary logic flow 300 wireless data network device (100) requests an access to the local wireless communication data network (101) providing its media access control address (404).

Such access request in an example can be explicitly (Start 1A) requested (301) by a user (110) of the wireless data network device (100). In another example, such access request can be automatically (Start 1B) attempted (302) by the wireless data network device (100). In either case (Start 1A) or (Start 1B), the proximity server (103) in an example checks (303) if the wireless data network device (100) with the specific media access control address (404) has been previously associated with any local wireless data communication networks controlled by the proximity server (103).

If in an example the media access control address (404) of the wireless data network device (100) has been found in the device database (312) queried by the proximity server (103) and associated with a mobile number (406) previously authenticated (303A), the proximity server (103) in an example grants the access to local wireless communication network (101) or (201), respectively, the wireless data network device (100) is currently operating in (305).

The software (106) stored in the memory (104) of the proximity server (103) in an example evaluates historical usage patterns (306) of the wireless data network device (100) and its current proximity location via interaction with the customer relationship management (CRM) system (109)).

Based on the results of historical evaluation (306), the proximity server (103) in an example pushes a mobile message (111) to the wireless data network device (100) with targeted ads or promotions via one or more of the signaling cellular network (107), the data cellular network (108) and/or the local wireless communication data network within which proximity the wireless data network device (100) operates, as determined by (307).

Alternatively, if the media access control address (404) of the wireless data network device (100) has not been found in the device database (312) by the proximity server (103) (303B), the proximity server (103) instructs the network access controller within which proximity the wireless data network device (100) operates to direct the wireless data network device (100) access request to the registration webpage hosted by the proximity server (103) and to render the registration webpage on the wireless data network device's screen (100) to instruct the user to provide a mobile number (406) so that the wireless data network device (100) can receive an access authorization confirmation for the local wireless communication data network via a mobile message (304).

After the proximity server (103) sends an access authorization confirmation message (304), it requires the user to reply with the confirmation reply mobile message content (308) back to the proximity server (103).

If the confirmation reply mobile message is received (308A) by the proximity server (103) the proximity server adds (309) an entry to the device database (312) of the media access control address (404) and the mobile number (406) and grants the full network access to the local wireless communication data network the wireless data network device (100) currently operates in (310).

If the confirmation reply mobile message is not received (308B) by the proximity server (103), the proximity server (103) denies access (311) to the local wireless data communication network within which proximity the wireless data network device (100) currently operates.

An implementation of the apparatus 10 comprises an algorithm, procedure, program, process, mechanism, engine, model, coordinator, module, unit, application, software, code, and/or logic. An implementation of the apparatus 10 comprises one or more user-level programs, for example, user interface logic residing in one or more user-level program files.

An implementation of the apparatus 10 comprises a plurality of components such as one or more of electronic components, chemical components, organic components, mechanical components, hardware components, optical components, and/or computer software components. A number of such components may be combined or divided in an implementation of the apparatus 10. One or more components of an implementation of the apparatus 10 and/or one or more parts thereof may comprise one or more of a computing, communication, interactive, and/or imaging device, interface, computer, and/or machine. One or more components of an implementation of the apparatus 10 and/or one or more parts thereof may serve to allow selection, employment, channeling, processing, analysis, communication, and/or transformation of electrical signals and/or between and/or among physical, logical, transitional, transitory, persistent, and/or electrical signals, inputs, outputs, measurements, and/or representations.

A plurality of instances of a particular component may be present in an implementation of the apparatus 10. One or more features described herein in connection with one or more components and/or one or more parts thereof may be applicable and/or extendible analogously to one or more other instances of the particular component and/or other components in an implementation of the apparatus 10. One or more features described herein in connection with one or more components and/or one or more parts thereof may be omitted from or modified in one or more other instances of the particular component and/or other components in an implementation of the apparatus 10. An exemplary technical effect is one or more exemplary and/or desirable functions, approaches, and/or procedures. An exemplary component of an implementation of the apparatus 10 may employ and/or comprise a set and/or series of computer instructions written in or implemented with any of a number of programming languages, as will be appreciated by those skilled in the art.

An implementation of the apparatus 10 may comprise any (e.g., horizontal, oblique, angled, or vertical) orientation, with the description and figures herein illustrating an exemplary orientation of an exemplary implementation of the apparatus 10, for explanatory purposes. One or more components of an implementation of the apparatus 10 and/or one or more parts thereof may occupy a number of locations of the apparatus 10.

An implementation of the apparatus 10 may encompass an article and/or an article of manufacture. The article may comprise one or more computer-readable signal-bearing media. The article may comprise means and/or instructions in the one or more media for one or more exemplary and/or desirable functions, approaches, and/or procedures.

An implementation of the apparatus 10 may employ one or more computer-readable signal-bearing media. A computer-readable signal-bearing medium may store software, firmware and/or assembly language for performing one or more portions of an implementation of the apparatus 10. An example of a computer-readable signal bearing medium for an implementation of the apparatus 10 may comprise a memory and/or recordable data storage medium of the memory 104, device database (312), and/or memory (403). A computer-readable signal-bearing medium for an implementation of the apparatus 10 in an example may comprise one or more of a magnetic, electrical, optical, biological, chemical, and/or atomic data storage medium. For example, an implementation of the computer-readable signal-bearing medium may comprise one or more flash drives, optical discs, memory cards, computer networks, CDs (compact discs), DVDs (digital video discs), hard drives, portable drives, and/or electronic memory. A computer-readable signal-bearing medium in an example may comprise a physical computer medium and/or computer-readable signal-bearing tangible medium.

The steps or operations described herein are examples. There may be variations to these steps or operations without departing from the spirit of the invention. For example, the steps may be performed in a differing order, or steps may be added, deleted, or modified.

Although exemplary implementation of the invention has been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a network access controller that interacts with a proximity server to create an association between a mobile number and a media access control address of a wireless data network device.

2. The apparatus of claim 1, wherein the proximity server authenticates the mobile number via mobile messaging pushed by the proximity server over one or more of a signaling cellular wireless network, a data cellular wireless network, and/or a local wireless communication data network.

3. The apparatus of claim 2, wherein the proximity server selects any one of the signaling cellular wireless network, the data cellular wireless network, and/or the local wireless communication data network that the proximity server determines meets a preference of a user of the wireless data network device.

4. The apparatus of claim 3, wherein the user comprises a customer, wherein the proximity server determines the preference of the customer through access to a customer preference specified in a customer relationship management (CRM) application.

5. The apparatus of claim 2, wherein the proximity server selects any one of the signaling cellular wireless network, the data cellular wireless network, and/or the local wireless communication data network that the proximity server determines meets one or more of a preference of a user of the wireless data network device, network availability, and/or network coverage.

6. An apparatus, comprising:
a proximity server that interacts with a device database associated with the proximity server, wherein the proximity server employs a customer relationship management (CRM) system to determine one or more targeted advertisements (ads) to be delivered to a wireless data network device via mobile message based on one or more of:
proximity of the wireless data network device to a known location of a wireless data communication network; and/or
historical usage patterns of the wireless data network device.

7. The apparatus of claim 6, wherein a targeted ad of the mobile message is pushed by the proximity server through employment of one or more of a signaling cellular wireless network, a data cellular wireless network, and/or a local wireless communication data network.

8. A method, comprising the steps of:
employing a device database to determine targeted mobile messages; and
delivering the targeted mobile messages to a wireless data network device based on one or more of:
proximity of the wireless data network device to a known location of a wireless data communication network; and/or
historical usage patterns of the wireless data network device.
